(19) United States
(12) Patent Application Publication
(10) Pub. No.: US 2023/0022244 A1
(43) Pub. Date: Jan. 26, 2023

(54) Distributed Sensor Inertial Measurement Unit

(71) Applicant: VK Integrated Systems, Inc., Fullerton, CA (US)

(72) Inventor: Vasilios K. Kapogianis, JR., Fullerton, CA (US)

(73) Assignee: VK Integrated Systems, Inc., Fullerton, CA (US)

(21) Appl. No.: 17/555,463

(22) Filed: Dec. 19, 2021

Related U.S. Application Data
(60) Provisional application No. 63/127,934, filed on Dec. 18, 2020.

(51) Int. Cl. G01P 15/18; G01P 3/44

(52) U.S. Cl. CPC G01P 15/18; G01P 3/44

(57) ABSTRACT

An inertial measurement unit with distributed sensors to provide superior accuracy for acceleration, angular velocity and in some cases orientation. By using a distributed sensor configuration, improved accuracy is possible by leveraging the geometric configuration of the sensor array. The devices and methods described below provide for a distributed sensor IMU with distributed accelerometers, in addition to optionally distributed magnetometers and a further optional gyroscope.

### FIELD OF THE INVENTIONS

The inventions described below relate to the field of inertial measurement units.

### BACKGROUND OF THE INVENTIONS

The Inertial Measurement Unit (IMU) is commonly used to detect acceleration, angular velocity and in some cases orientation of a system in some inertial reference frame, often with respect to the Earth's magnetic field. Various types of IMU's exist, some as 6-degrees of freedom (DOF) sensors where the output is a processed combination of an accelerometer and gyroscope. Other types of IMU's exist with 9-DOF where the combination of accelerometers, gyroscopes and magnetometers output acceleration, angular velocity and sense the Earth's magnetic field, in three axes with respect to the sensor's origin. Accuracy over extended periods of time and form factor have been drawbacks that have always been a function of gyroscope and magnetometer accuracy. A common source of error in the angular velocity output of the IMU is the gyroscope sensor bias. Magnetometer resolution also suffers over time as a result of form factor, sensor type and placement.

### SUMMARY

The devices and methods described below provide for an inertial measurement unit with distributed sensors to provide superior accuracy for acceleration, angular velocity and in some cases orientation. By using a distributed sensor configuration, improved accuracy is possible by leveraging the geometric configuration of the sensor array. The devices and methods described below provide for a distributed sensor IMU with distributed accelerometers, in addition to optionally distributed magnetometers and a further optional gyroscope.

A first distributed sensor IMU creates six or more accelerometer signals generated by six or more distributed accelerometers in a known and fixed geometric configuration or accelerometer arrays such as two accelerometer triads formed of three orthogonally oriented accelerometers. The accelerometers are distributed and configured geometrically in any number of suitable configurations not limited to linear, coplanar, sensors aligned with the vertices of a polyhedron, sensors aligned with the surfaces of a polyhedron and sensors aligned on both surfaces and vertices of the polyhedron. All of the signals from the accelerometers are processed using an algorithmic process to produce an IMU having a low power consumption, application specific volume, smaller weight, large dynamic range and short reaction time.

An alternate distributed sensor IMU includes the accelerometers as discussed above and further includes six or more magnetometer signals generated by six or more distributed magnetometers in a known and fixed geometric configuration or magnetometer arrays such as or two magnetometer triads formed of three orthogonally oriented magnetometers. The magnetometers are distributed and configured geometrically in any number of suitable configurations not limited to linear, coplanar, with the sensors aligned with the vertices of a polyhedron, the sensors aligned with the surfaces of a polyhedron and sensors aligned with both the surfaces and vertices of the polyhedron. The combination of distributed accelerometers and distributed magnetometers may have all the sensors oriented similarly or differently, yet the accelerometers and magnetometers have no effect on each other's system model. Thus, a magnetometer and accelerometer may be coplanar or collinear and in close proximity, while having no adverse effects on the solution of their respective systems. All of the signals from the accelerometers and magnetometers are processed using an algorithmic process.

Yet another alternate distributed sensor IMU includes the accelerometers and magnetometers as discussed above and further includes a gyroscope to compare with the angular velocity prediction that results from integrating the system solution which is a virtual gyroscope. The optional gyroscope may be used to enhance the angular velocity performance.

### BRIEF DESCRIPTION OF THE DRAWINGS

FIG. 1 is a block diagram of a distributed sensor IMU with a plurality of distributed accelerometers.

FIG. 2 is a block diagram of a distributed sensor IMU with a plurality of distributed accelerometers and magnetometers.

FIG. 3 is a block diagram of a distributed sensor IMU with a plurality of distributed accelerometers, magnetometers and a gyroscope.

FIG. 4 is a flowchart for the Accelerometer Distributed IMU of FIG. 1 with steps for the optional magnetometers of FIG. 2 and the optional gyroscope of FIG. 3 illustrated in broken lines.

FIG. 5 is a flowchart of the optional distributed Accelerometer IMU of FIG. 1 with steps for the optional magnetometer array of FIG. 2 as well as an optional disturbance controller.

### DETAILED DESCRIPTION OF THE INVENTIONS

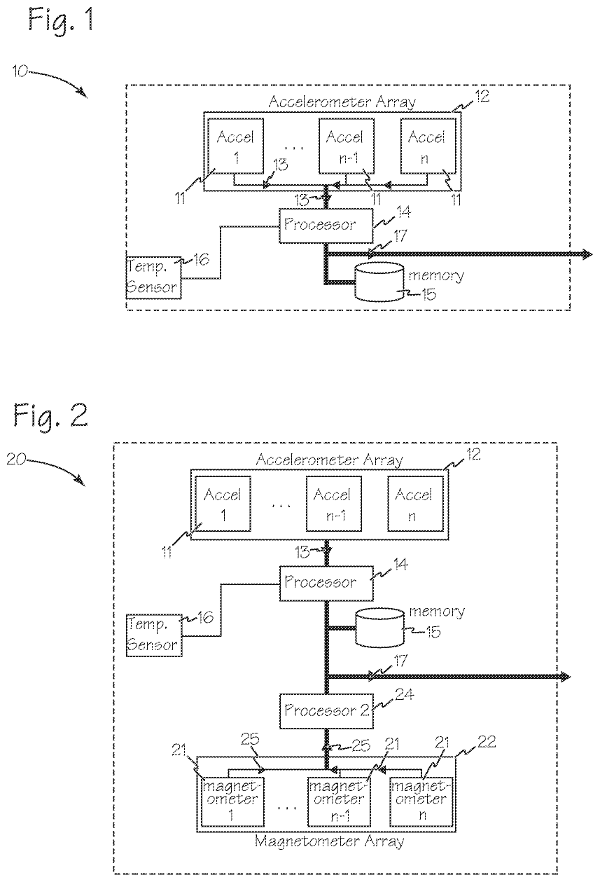

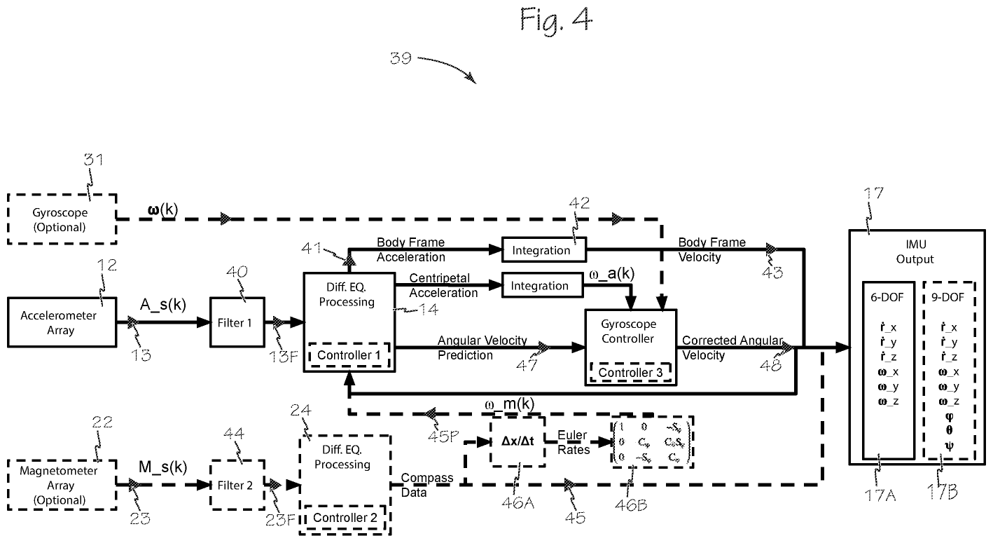

FIG. 1 illustrates distributed sensor IMU 10 which includes a minimum of six distributed acceleration sensors or accelerometers 11 which are arranged in any suitable known and fixed geometric configuration such as array 12 or any suitable accelerometer arrays such as two accelerometer triads formed of three orthogonally oriented accelerometers. The accelerometers are distributed and configured geometrically in any number of suitable configurations not limited to: linear, coplanar, sensor axes aligned with the vertices of a polyhedron, sensor axes aligned with the surfaces of a polyhedron or sensors mounted on both surfaces and vertices of the polyhedron. All of the acceleration signals 13 from the accelerometers are processed by processor 14 using the algorithmic process of FIG. 4 in combination with memory 15 to produce IMU output signal 17. Temperature sensor 16 provides calibration data for the components of the IMU. IMU output signal 17 is transmitted to any suitable system such as a transmitter or to a local device for display and action by any suitable user. Accordingly, a distributed sensor IMU such as IMU 10 has a low power consumption, application specific volume, smaller weight and a large dynamic range.

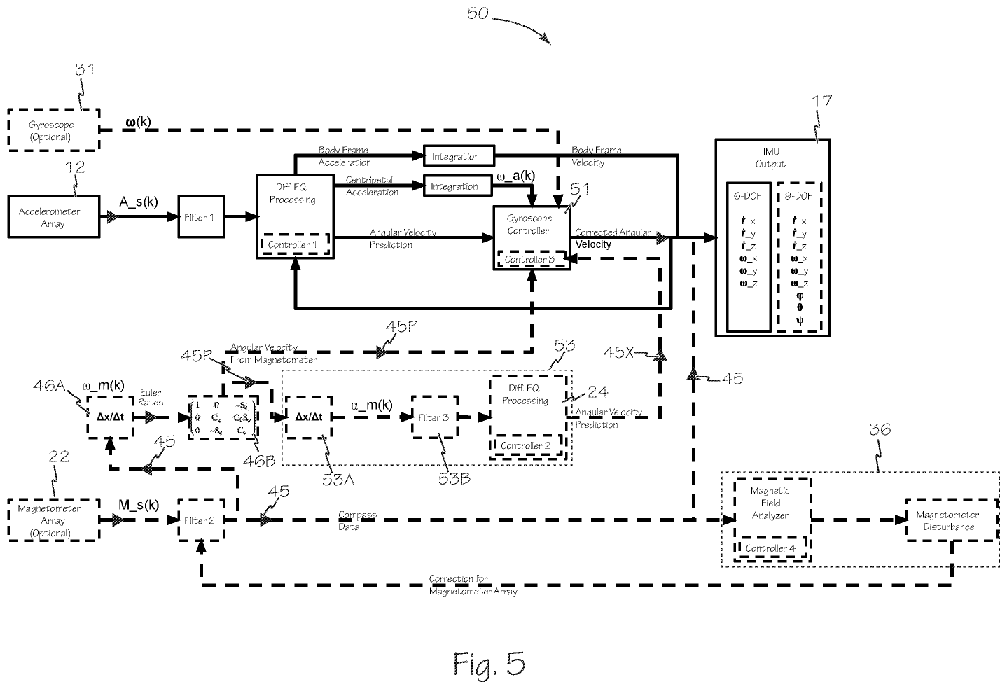

FIG. 2 illustrates distributed sensor IMU 20 includes the accelerometer array 12 providing at least six accelerometer signals 13 as discussed above and further includes a minimum of six magnetometers in a known and fixed geometric configuration of magnetometer sensors such as magnetometers 21 are configured as magnetometer array 22 or any suitable magnetometer arrays such as two magnetometer triads formed of three orthogonally oriented magnetometers. The magnetometers 21 are distributed and configured geometrically in any number of suitable configurations not limited to: linear, coplanar, sensors lining with the vertices of a polyhedron, sensors aligned with the surfaces of a polyhedron and sensors mounted on both surfaces and vertices of the polyhedron. The combination of distributed accelerometer sensors 11 and distributed magnetometer sensors 21 may have all the sensors oriented similarly or differently, yet the accelerometers and magnetometers have no effect on each other's system model. Thus, a magnetometer and accelerometer may be coplanar or collinear and in close proximity, while having no adverse effects on the solution of their respective systems. All of the magnetometer sensor signals 23 from the magnetometer sensors are processed by processor 14 and second processor 24 in combination with memory 15 using the algorithmic process of either FIG. 4 or 5. Accordingly, a magnetometer and accelerometer distributed sensor IMU such as IMU 20 has a low cost, low power consumption, application specific volume, smaller weight, a large dynamic range and a short reaction time.

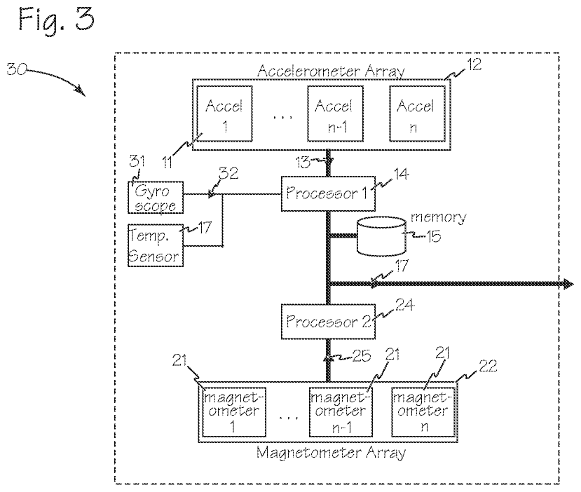

FIG. 3 illustrates yet another alternate distributed sensor IMU, distributed sensor IMU 30 which includes the accelerometers 11 and magnetometers 21 as discussed above and further includes an optional gyroscope 31 to compare with the angular velocity prediction that results from integrating the system solution which is a virtual gyroscope. Gyroscope 31 produces gyro signals 32 which are processed along with the accelerometer and magnetometer sensor signals as discussed above by processor 14 and second processor 24 in combination with memory 15 using the algorithmic process of either FIG. 4 or 5. The optional gyroscope may be used to enhance the angular velocity performance.

The optional disturbance controller 36 illustrated in FIG. 5 for the distributed magnetometer array provides the ability to detect the transient signals and variations in magnetic field to make it possible to compensate for objects that affect the magnetic field in the immediate vicinity of the magnetometer array.

Each IMU includes an array of multiple accelerometers in a fixed geometric configuration to enable precise motion tracking as well as capturing vibration data. Each accelerometer consists of 3 orthogonally oriented single axis accelerometers. The IMU includes a processor, a temperature sensor and memory. Optionally the IMU may include a physical Gyroscope to compare with the angular velocity prediction that results from integrating the system solution (virtual gyroscope). This gyroscope may also be in the form of a microelectronic mechanical systems (MEMS) IMU and may be used to enhance the angular velocity performance.

The algorithmic processes 39 and 50 illustrated in FIGS. 4 and 5 respectively, leverage the distributed nature of the magnetometer and accelerometer arrays and uses model-based nonlinear state estimation techniques to obtain the digital compass, angular velocity 48 and linear velocity 43 signals with respect to a user defined origin. Thus the distributed sensor IMU may replace most MEMS IMU's in its class, containing the availability to output user configurable data as IMU output 17 such as linear and angular accelerations, linear and angular velocity as well as Euler angles with digital compass.

The first process 39 of FIG. 4 starts with output signals 13 from each of the 6 or more accelerometers of accelerometer array 12. The array output signals 13 are applied to first filter 40 and the filtered output signals 1340F are applied to accelerometer processor or controller 14 for differential equation processing. The processed accelerometer outputs represent body frame acceleration 41 and it is integrated at step 42 to determine the body frame velocity 43. The body frame velocity 43 is output as either 6 degree of freedom output 17A or 9 degree of freedom output 17B. The body frame velocity 43 is also applied as feedback to accelerometer processor 14.

If the optional magnetometer array 22 is included, the magnetometer output signals 23 are applied to second filter 44 and the filtered output signal 23F are applied to the magnetometer processor or controller 24. The magnetometer processor or controller 24 produces compass data 45 which is processed in steps 46A and 46B to produce processed magnetometer data 45P which is applied to accelerometer processor 14 to improve the accuracy of linear and angular velocity calculations. Compass data 45 is also applied to IMU output 17 and is available as either 6 degree of freedom output 17A or 9 degree of freedom output 17B.

Inclusion of the optional gyroscope 31 enables a comparison between the angular velocity prediction 47 that results from integrating the system solution 48 with gyroscope data 32 which functions as a virtual gyroscope.

The second algorithmic process 50 of FIG. 5 is very similar to first algorithmic process 39 with respect to the processing of accelerometer signals 13. Magnetometer signals 23 are processed differently. Compass data 45 is still applied to output 17, however, it is also applied to optional magnetic field disturbance controller 36 as discussed above. Compass data 45 is also processed in steps 46A and 46B to produce processed magnetometer data 45P which is applied to gyroscope controller 51 to improve the calculation of corrected angular velocity 52. Processed magnetometer data 45P is also applied to differential equation system 53 with differential calculator 53A, filter 53B and magnetometer processor 24 which generates angular velocity prediction 45X which is applied to gyroscope controller 51 to further improve corrected angular velocity 52.

While the preferred principles of the inventions. The elements of the various embodiments may be incorporated into each of the other species to obtain the benefits of those elements in combination with such other species, and the various beneficial features may be employed in embodiments alone or in combination with each other. Other embodiments and configurations may be devised without departing from the spirit of the inventions and the scope of the appended claims.

1. A distributed inertial measurement unit comprising:
six or more accelerometers oriented in a distributed array, each accelerometer producing an output signal, the six or more accelerometer output signals are processed by a first signal processor to produce an acceleration signal and a velocity signal;
six or more magnetometers oriented in a distributed array, each magnetometer producing an output signal, the six or more magnetometer output signals processed by a second processor to produce compass data and processed compass data, the processed compass data is applied to the first processor to produce an angular velocity prediction and centripetal acceleration signals.

2. The distributed inertial measurement unit of claim 1 wherein the accelerometers are oriented in distributed array with each of the six or more accelerometers aligned with the vertices of a polyhedron.

3. The distributed inertial measurement unit of claim 1 wherein the accelerometers are oriented in distributed array with each of the six or more accelerometers aligned with the surfaces of a polyhedron.

4. The distributed inertial measurement unit of claim 1 wherein the accelerometers are oriented in distributed array with each of the six or more accelerometers aligned with the vertices and surfaces of a polyhedron.

5. The distributed inertial measurement unit of claim 1 wherein the magnetometers are oriented in distributed array with each of the six or more magnetometers aligned with the vertices of a polyhedron.

6. The distributed inertial measurement unit of claim 2 wherein the magnetometers are oriented in distributed array with each of the six or more magnetometers aligned with the vertices of a polyhedron.

7. The distributed inertial measurement unit of claim 3 wherein the magnetometers are oriented in distributed array with each of the six or more magnetometers aligned with the vertices of a polyhedron.

8. The distributed inertial measurement unit of claim 4 wherein the magnetometers are oriented in distributed array with each of the six or more magnetometers aligned with the vertices of a polyhedron.

9. The distributed inertial measurement unit of claim 1 wherein the magnetometers are oriented in distributed array with each of the six or more magnetometers aligned with the vertices and surfaces of a polyhedron.

10. The distributed inertial measurement unit of claim 2 wherein the magnetometers are oriented in distributed array with each of the six or more magnetometers aligned with the vertices and surfaces of a polyhedron.

11. The distributed inertial measurement unit of claim 3 wherein the magnetometers are oriented in distributed array with each of the six or more magnetometers aligned with the vertices and surfaces of a polyhedron.

12. The distributed inertial measurement unit of claim 4 wherein the magnetometers are oriented in distributed array with each of the six or more magnetometers aligned with the vertices and surfaces of a polyhedron.

13. The distributed inertial measurement unit of claim 1 wherein the first signal processor produces an angular velocity prediction signal and a centripetal velocity signal and the distributed inertial measurement unit further comprises:
a third signal processor operatively connected to the first signal processor to receive and process the angular velocity prediction signal and a centripetal acceleration;
a gyroscope producing a gyroscope output signal that is operatively connected to the third signal processor.

14. The distributed inertial measurement unit of claim 1 wherein the magnetometers are oriented in distributed array with each of the six or more magnetometers aligned with the surfaces of a polyhedron.

15. The distributed inertial measurement unit of claim 2 wherein the magnetometers are oriented in distributed array with each of the six or more magnetometers aligned with the surfaces of a polyhedron.

16. The distributed inertial measurement unit of claim 3 wherein the magnetometers are oriented in distributed array with each of the six or more magnetometers aligned with the surfaces of a polyhedron.

17. The distributed inertial measurement unit of claim 4 wherein the magnetometers are oriented in distributed array with each of the six or more magnetometers aligned with the surfaces of a polyhedron.
